(19) United States
(12) Patent Application Publication
(10) Pub. No.: US 2026/0170338 A1
(43) Pub. Date: Jun. 18, 2026

(54) FINE-TUNING GENERATIVE MODELS FOR RESOURCE ALLOCATION TASKS

(71) Applicant: Microsoft Technology Licensing, LLC, Redmond, WA (US)

(72) Inventors: Yuchen LI, Redmond, WA (US); Nicholas Christian MATTON, Los Angeles, CA (US)

(73) Assignee: Microsoft Technology Licensing, LLC, Redmond, WA (US)

(21) Appl. No.: 18/985,182

(22) Filed: Dec. 18, 2024

(51) Int. Cl. G06N 3/082; G06N 3/0455

(52) U.S. Cl. CPC G06N 3/082; G06N 3/0455

(57) ABSTRACT

A data processing system implements generating via an AI model synthetic resource allocation sample solutions based on resource allocation data associated with resource(s), the resource allocation data including event data points (each of which including a start, a duration, at least one of the resource(s), and one or more resource consuming entities), and the resource(s) including a physical space, a memory storage space, computation power, utilities, transportation capabilities, communication network capabilities, and/or workforce; executing via a target generative model a validation function over the resource allocation data to rank and select a top-ranked synthetic resource allocation sample solution, the validation function including resource allocation performance factor(s) (including schedule disturbance minimization, scheduling conflict resolution maximization, or execution steps minimization); labeling resource allocation data associated with the top-ranked synthetic resource allocation sample solution as labeled resource allocation data; and fine-tuning the target generative model based on the labeled resource allocation data.

### BACKGROUND

Modern life is busy and demanding with many different types of personal and work tasks. Common strategies to improve resource allocation and productivity include task prioritization, tasks scheduling, resource utilization optimization, and the like. In terms of tasks scheduling, an entity may be actively working on different tasks associated with multiple projects and resources (e.g., facilities, equipment, personals, network, and the like). As a result, the entity may struggle to keep track of the timing and states of these tasks/projects and the respective resources. This may lead to frustration and inefficiency. Artificial intelligence (AI) has been applied to automate our lives to optimize resource allocation and increase productivity. For instance, Reinforcement Learning from Human Feedback (RLHF) is used to post-train a large language model (LLM) for a resource allocation task (e.g., resource allocation) involves human feedback. Direct Nash Optimization (DNO) can be applied to improve RLHF by replacing the human feedback with LLMs as preference annotators. However, there are technical challenges to realize DNO's AI-powered preference annotation, since DNO's optimal solution that imitates real user behavior may be ill-defined, and DNO's exponentially-difficult perfect conflict resolution for all event attendees impacted by a single event change may not be computable. Hence, there is a need for improving systems and methods of fine-tuning a generative model for a resource allocation task.

### SUMMARY

An example data processing system according to the disclosure includes a processor and a machine-readable medium storing executable instructions. The instructions when executed cause the processor alone or in combination with other processors to perform operations including generating via an artificial intelligence model synthetic resource allocation sample solutions based on resource allocation data associated with one or more resources, wherein the resource allocation data includes event data points, each of which including a start, a duration, at least one of the one or more resources, and one or more resource consuming entities, and wherein the one or more resources include at least one of a physical space, a memory storage space, computation power, utilities, transportation capabilities, communication network capabilities, or workforce; executing via a target generative model a validation function over the resource allocation data to rank the synthetic resource allocation sample solutions and to select a top-ranked synthetic resource allocation sample solution among the synthetic resource allocation sample solutions, wherein the validation function includes one or more resource allocation performance factors, and the one or more resource allocation performance factors include schedule disturbance minimization, scheduling conflict resolution maximization, or execution steps minimization; labeling resource allocation data associated with the top-ranked synthetic resource allocation sample solution as labeled resource allocation data; and fine-tuning the target generative model based on the labeled resource allocation data.

An example method implemented in a data processing system includes generating via an artificial intelligence model synthetic resource allocation sample solutions based on resource allocation data associated with one or more resources, wherein the resource allocation data includes event data points, each of which including a start, a duration, at least one of the one or more resources, and one or more resource consuming entities, and wherein the one or more resources include at least one of a physical space, a memory storage space, computation power, utilities, transportation capabilities, communication network capabilities, or workforce; executing via a target generative model a validation function over the resource allocation data to rank the synthetic resource allocation sample solutions and to select a top-ranked synthetic resource allocation sample solution among the synthetic resource allocation sample solutions, wherein the validation function includes one or more resource allocation performance factors, and the one or more resource allocation performance factors include schedule disturbance minimization, scheduling conflict resolution maximization, or execution steps minimization; labeling resource allocation data associated with the top-ranked synthetic resource allocation sample solution as labeled resource allocation data; and fine-tuning the target generative model based on the labeled resource allocation data.

An example non-transitory computer readable medium data processing system according to the disclosure on which are stored instructions that, when executed, cause a programmable device to perform functions of generating via an artificial intelligence model synthetic resource allocation sample solutions based on resource allocation data associated with one or more resources, wherein the resource allocation data includes event data points, each of which including a start, a duration, at least one of the one or more resources, and one or more resource consuming entities, and wherein the one or more resources include at least one of a physical space, a memory storage space, computation power, utilities, transportation capabilities, communication network capabilities, or workforce; executing via a target generative model a validation function over the resource allocation data to rank the synthetic resource allocation sample solutions and to select a top-ranked synthetic resource allocation sample solution among the synthetic resource allocation sample solutions, wherein the validation function includes one or more resource allocation performance factors, and the one or more resource allocation performance factors include schedule disturbance minimization, scheduling conflict resolution maximization, or execution steps minimization; labeling resource allocation data associated with the top-ranked synthetic resource allocation sample solution as labeled resource allocation data; and fine-tuning the target generative model based on the labeled resource allocation data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1A is a diagram of an example computing environment in which the techniques for fine-tuning generative models for resource allocation tasks are implemented.

FIG. 1B is a diagram showing features of an AI model training unit of the application services platform shown in FIG. 1A.

FIG. 2 is a conceptual diagram of an AI-powered query-rank-train framework for fine-tuning generative models for resource allocation tasks implemented by the application services platform shown in FIG. 1A.

FIGS. 3A-3B are diagrams of example data views of a data dump and an allocation schedule prior to a validation function of an AI model training unit that implements the techniques described herein.

FIG. 4 is a flow chart of an example process for fine-tuning generative models for resource allocation tasks according to the techniques disclosed herein.

FIG. 5 is a block diagram showing an example software architecture, various portions of which may be used in conjunction with various hardware architectures herein described, which may implement any of the described features.

FIG. 6 is a block diagram showing components of an example machine configured to read instructions from a machine-readable medium and perform any of the features described herein.

### DETAILED DESCRIPTION

Systems and methods for fine-tuning generative AI for resource allocation tasks are described herein. These techniques provide a technical solution to the technical problems of AI-powered preference annotation (e.g., DNO), such as computation complexity or unfeasible computation for fine-tuning generative AI for resource allocation tasks.

Referring back to RLHF discussed in the Background section, it has two key components: reward learning and policy optimization, which work together to align AI behavior with human preferences. A reward model is trained to interpret human feedback and assign a reward score to an AI's actions. The reward model replaces traditional hand-designed reward functions, ensuring the AI optimizes behavior that aligns with human values. The reward model guides the AI's policy, which defines how the AI selects actions. Using reinforcement learning algorithms (e.g., DNO), the policy is fine-tuned to maximize the learned reward. For instance, DNO uses AI-simulated preference feedback to help an LLM iteratively improve over itself for calendar conflict resolution. A preference oracle or function is used by DNO to rank multiple calendar completions generated for the same input. Those ranked calendar completions are then used to implement a contrastive learning step that updates the LLM. However, such contrastive learning step requires a large number of pairwise comparisons or negative samples, which increases training time and computational cost. In addition, the contrastive learning step relies strongly on well-designed data augmentation techniques to generate meaningful contrasts, making performance heavily dependent on augmentation quality.

To address these technical problems, the inventors propose an AI-powered query-rank-train framework for fine-tuning a generative model for a resource allocation task based on a validation function including performance factors tailored for the resource allocation task. The resource allocation framework can fine-tune a generative model to handle various resource allocation tasks with greater simplicity and cost reduction. The resources can be a physical space, a memory storage space, computation power, utilities, transportation capabilities, communication network capabilities, workforce, and the like. For instance, for handling information technology (IT) worker calendar conflicts, such validation function includes performance factors like schedule disturbance minimization, scheduling conflict resolution maximization, execution steps minimization, and the like.

In addition, the query-rank-train framework also formats resource allocation data into a text representation of an allocation schedule (e.g., calendar surface) to trim down the event data size based deduction hyperparameters, such as a character size per column, a number of time segments per hour, a maximum number of events per row in a column per day in the schedule surface, and the like.

In one implantation, the framework fine-tunes an LLM on calendar data for the task of conflict resolution. The core innovative part includes the text representation of the calendar surface that reduces LLM reasoning load, the first pass and the validation function. The technical advantages include fewer LLM calls, faster training iterations and realistic rescheduling validation functions

Although various embodiments are described with respect to fine-tuning LLMs, it is contemplated that the approach described herein may be applied to fine-tuning other generative models (e.g., vision models) for resource allocation tasks, depending on the input and output data type/format requirements (e.g., text, audio, diagrams, videos, and the like) as well as other considerations. Although various embodiments are described with respect to fine-tuning a generative model to resolve calendar conflicts, it is contemplated that the approach described herein may be applied to fine-tune a generative model for any resource allocation tasks. Resource allocation involves assigning and scheduling resources (e.g., people, materials, equipment, and the like) to specific tasks or projects to achieve objectives effectively.

A technical benefit of the approach provided herein is to support entities (e.g., enterprises, end users, etc.) to fine-tune their generative models for a resource allocation task with greater simplicity and cost reduction via the AI-powered query-rank-train framework and a validation function designed for the task. The resources can be a physical space, a memory storage space, computation power, utilities, transportation capabilities, communication network capabilities, workforce, etc. In short, the AI-powered query-rank-train framework simplifies DNO to reduce the resources needed for fine-tuning, thereby saving time and computational expenses.

Another technical benefit of this approach provided herein is to format the resource allocation data into a text representation of an allocation schedule (e.g., a calendar surface) to trim down the event data thus reduce to be validated data size (i.e., reasoning load). Another technical benefit of this approach is applying the AI-powered query-rank-train framework to fine-tune any generative models tailored for different resource allocation tasks in various applications (e.g., an email application, calendar application, task management application, and the like) to generate a resource allocation schedule comprehensively, quickly and accurately, via a chat interface.

Yet another technical benefit of this approach is to provide users interactive tools to refine the resource allocation schedule, and infer actions to complete tasks in the resource allocation schedule. A user can use an AI-assisted resource allocation application that supports the query-rank-train framework at the start of a day, and views a resource allocation schedule with task events and suggested actions to complete each task event. These and other technical benefits of the techniques disclosed herein will be evident from the discussion of the example implementations that follow.

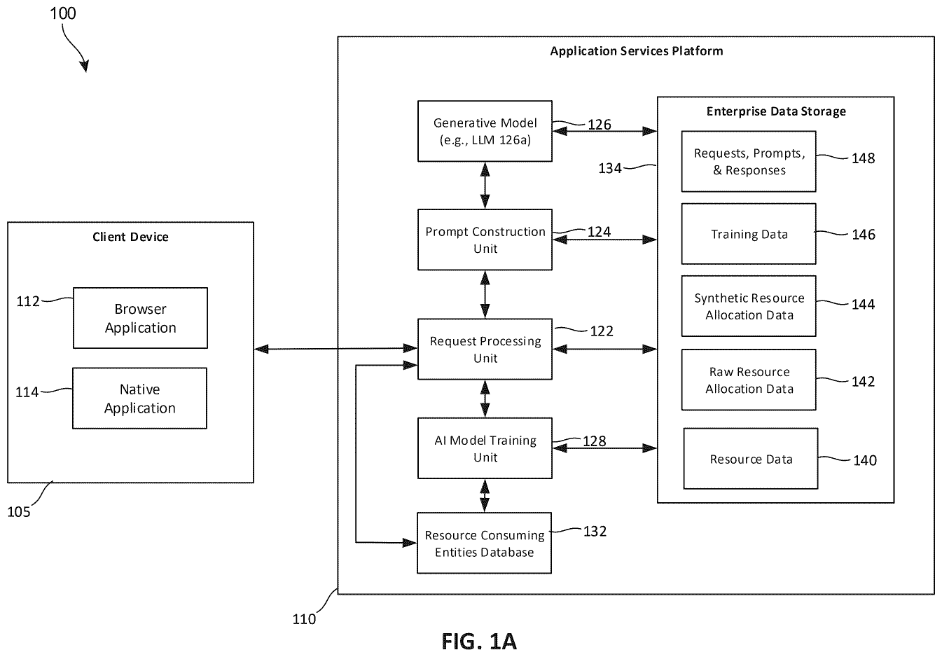

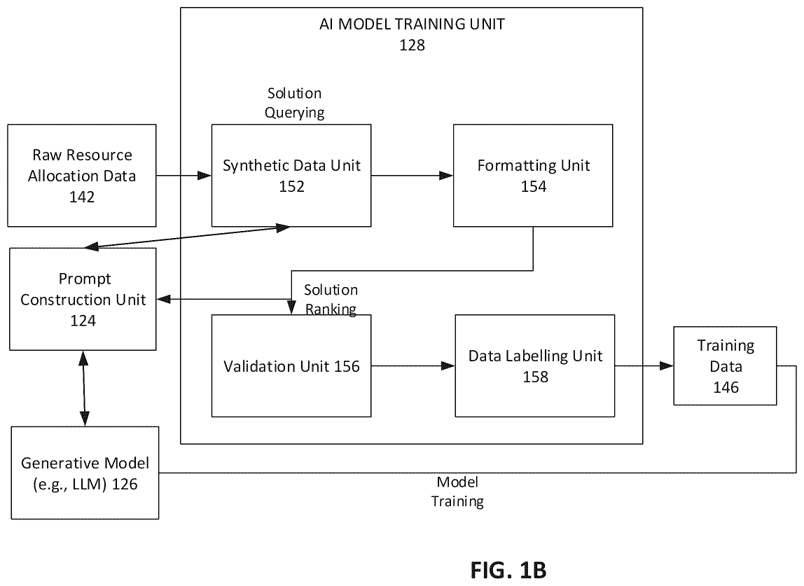

FIG. 1A is a diagram of an example computing environment 100 in which the techniques herein may be implemented. The example computing environment 100 includes a client device 105 and an application services platform 110. The application services platform 110 provides one or more cloud-based applications and/or provides services to support one or more web-enabled native applications on the client device 105. These applications may include but are not limited to resource allocation assistant applications (e.g., project management tools like Float® and Quickbase®, human resource allocation platforms like Runn®, and the like), presentation applications, website authoring applications, collaboration platforms, communications platforms, and/or other types of applications in which users may fine-tune a generative model for different resource allocation tasks. In the implementation shown in FIG. 1A, the application services platform 110 also applies generative AI to generate fast and accurate resource allocation outputs upon user demand via various online and/or offline entity task/event sources according to the techniques described herein. A task/project may require or involve multiple events. For instance, the task is to resolve calendar conflicts of a group of developers working on the same software testing project.

In one embodiment, the application services platform 110 is independently implemented on the client device 105. In another embodiment, the client device 105 and the application services platform 110 communicate with each other over a network (not shown) to implement the system. The network may be a combination of one or more public and/or private networks and may be implemented at least in part by the Internet.

The client device 105 is a computing device that may be implemented as a portable electronic device, such as a mobile phone, a tablet computer, a laptop computer, a portable digital assistant device, a portable game console, and/or other such devices in some implementations. The client device 105 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 1A includes a single client device 105, other implementations may include a different number of client devices that utilize services provided by the application services platform 110.

As used herein, the term “resource” refers something that can be used to achieve a goal, support a need, or provide benefit, including but not limited to physical space, a memory storage space, computation power, utilities, transportation capabilities, communication network capabilities, natural resources (e.g., water, minerals, forests, energy sources), economic or financial resources (e.g., money, assets, etc.), human resources (e.g., workforce talents or skills), tools, materials, or mechanisms that provides relief or assistance, and the like.

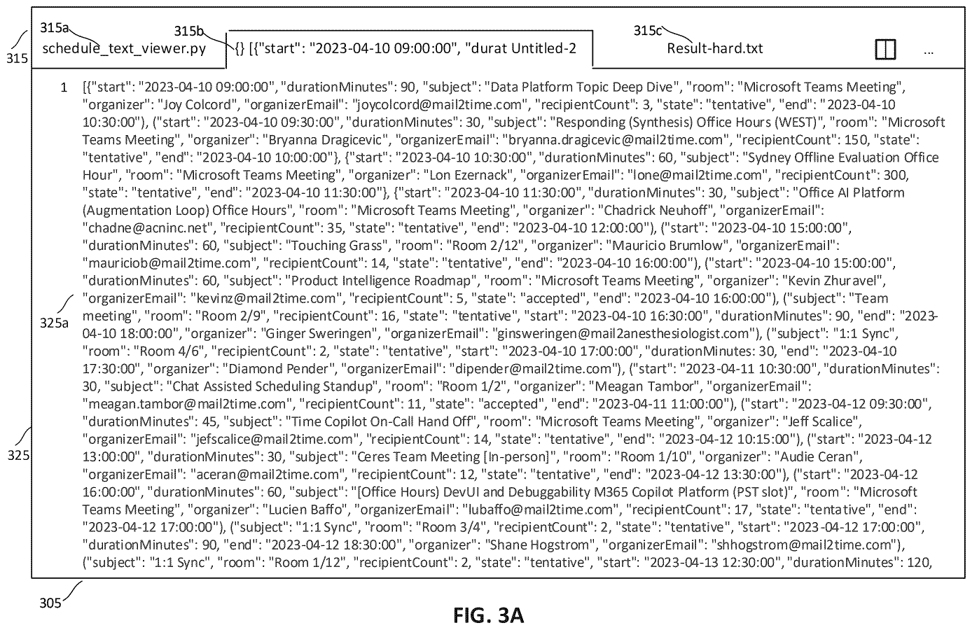

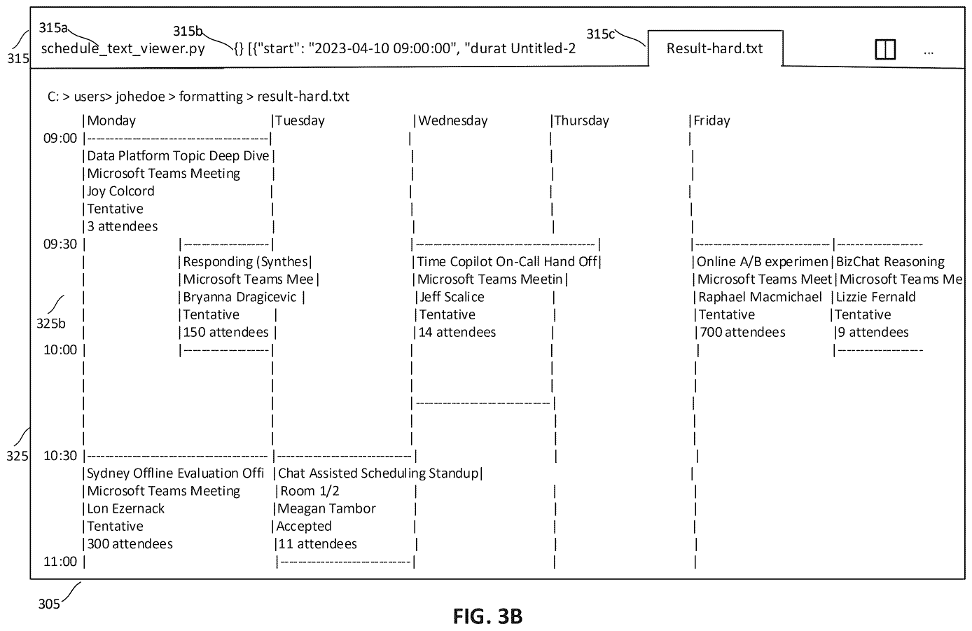

The client device 105 includes a native application 114 and a browser application 112. The native application 114 is a web-enabled native application, in some implementations, which enables users to view, create, and/or modify resource allocation task schedules. The web-enabled native application utilizes services provided by the application services platform 110 including but not limited to obtaining resource allocation data, and fine-tuning a generative model for various types of resource allocation task schedules using the resource allocation data. The native application 114 implements a user interface 305 shown in FIGS. 3A-3B in some implementations. In other implementations, the browser application 112 is used for accessing and viewing web-based content provided by the application services platform 110. In such implementations, the application services platform 110 implements one or more web applications, such as the browser application 112, that enables users to fine-tune a generative model for different resource allocation tasks. The browser application 112 implements the user interface 305 shown in FIGS. 3A-3B in some implementations. The application services platform 110 supports both the native application 114 and the browser application 112 in some implementations, and the users may choose which approach best suits their needs.

In one embodiment, the application services platform 110 includes a request processing unit 122, a prompt construction unit 124, a generative model 126, and an AI model training unit 128. In other embodiments, the application services platform 110 also includes a resource consuming entity database 132, an enterprise data storage 134, and/or moderation services.

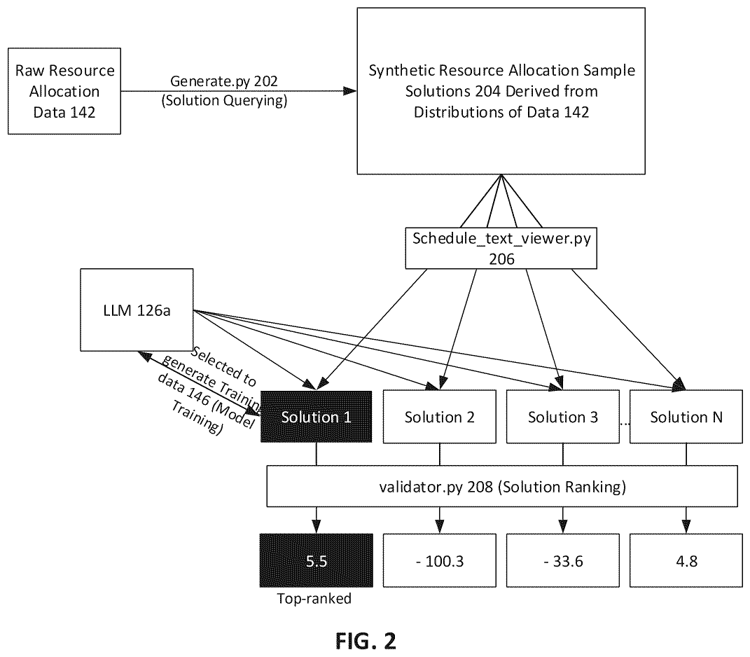

The request processing unit 122 is configured to receive requests from the native application 114 and/or the browser application 112 of the client device 105. The requests may include but are not limited to requests to fine-tune a generative model 126 for different resource allocation tasks (explained in detail in conjunction with FIG. 2) and/or sending natural language prompts to the generative model 126 to generate a resource allocation schedule using the fine-tuned model according to the techniques provided herein. The generative model 126 can be selected for a use case considering the specific knowledge base, the availability of pre-trained models, and the like. The request processing unit 122 also coordinates communication and exchange of data among components of the application services platform 110 as discussed in the examples which follow.

The prompt construction unit 124 is responsible for creating and refining prompts to interact effectively with the generative model 126. This involves designing input instructions that guide the generative model 126 to produce accurate and contextually relevant outputs. The key tasks of the prompt construction unit 124 in the AI-powered query-rank-train framework include working in conjunction with the AI model training unit 128 to construct prompts to an AI model (e.g., the LLM 126a) to generate synthetic resource allocation sample solutions, to execute a validation function over resource allocation data to rank the synthetic resource allocation sample solutions, and to select a top-ranked synthetic resource allocation sample solution. In one implementation, in response to a user request, the prompt construction unit 124 calls the fined-tuned model to execute conflict resolution on subsequent resource allocation data.

In one embodiment, the generative model 126 is a language model trained to generate content (e.g., textual, spreadsheet, chart, report, audio, image, video, and the like) in response to natural language prompts input by a user via the native application 114 or via the web. For instance, the generative model 126 is implemented using a large language model (LLM) in some implementations. Examples of such models include but are not limited to Generative Pre-trained Transformer 4 (GPT-4), Claude®, BERT® (Bidirectional Encoder Representations from Transformers), Falcon 40BR, Gemini®, CodeWhisperer®, and the like. Other implementations may fine-tune other generative models for resource allocation tasks according to the query-rank-train framework.

The AI model training unit 128 performs many functions of the AI-powered query-rank-train framework. FIG. 1B is a diagram showing features of the AI model training unit 128 of the application services platform 110. In one embodiment, the AI model training unit 128 includes a synthetic data unit 152, a formatting unit 154, a validation unit 156, and a data labelling unit 158. In one implementation, a user (e.g., a software developer) activates a command line interface (CLI) tool on a user interface 305 of the client device 105, and then inputs via the CLI a user request to fine-tune an LLM 126a for a resource allocation task (e.g., IT worker calendar conflict resolution). The request processing unit 122 receives the user request and transmits the request to the AI model training unit 128. For instance, the AI model training unit 128 implements the query-rank-train framework using python. FIG. 2 is a conceptual diagram of applying such query-rank-train framework for fine-tuning the generative model 126 for resource allocation tasks implemented by the application services platform 110, using data retrieved from the enterprise data storage 134. For instance, the enterprise data storage 134 stores resource data 140, raw resource allocation data 142, synthetic resource allocation data 144, training data 146, and request, prompts and responses 148.

Continuing with the example task of IT worker calendar conflict resolution, the AI model training unit 128 applies the query-rank-train framework in FIG. 2 to fine-tune the LLM 126a in response to the user request. The query-rank-train framework consists of three stages: query, rank, train. In the solution querying stage, the AI model training unit 128 requests a first AI model to generate k completions/solutions per event data point (Dₜ={(x, y^{gold})} where x˜ρ and y˜π_{gold}(·|x)), where k is a hyperparameter that can be tuned by the inventors and/or users. The first AI model can be a generative model (e.g., the to be fine-tuned LLM 126a, or a different generative model) or a machine learning model. For instance, the synthetic data unit 152 of the AI model training unit 128 interacts with the LLM 126a to generate k calendar completions/solutions in the solution querying stage in FIG. 1B.

In the solution ranking stage, the AI model training unit 128 determines the best completion/solution using a validation/preference function, rating each completion/solution based on a set of objective measures. The validation/preference function cab be run by the first AI model, or a different AI model. Similarly, the different AI model can be a generative model or a machine learning model. For instance, the validation unit 156 of the AI model training unit 128 interacts with the LLM 126a to execute the validation function to rank calendar solutions in the solution ranking stage in FIG. 1B.

In the model training (to be exact, post-training or fine-tuning) stage, the data labelling unit 158 of the AI model training unit 128 labels each of the event data point of the top-ranked completion/solution y, and then the AI model training unit 128 runs a single epoch of training on the target LLM 126a using newly labeled data. The AI model training unit 128 then repeats this process for a set number of iterations to fine-tune the target LLM 126a as the algorithm shown in Table 1.

```
TABLE 1
Input: validation function V, learning rate η, iterations T, reference policy π_{ref}, prompt
distribution ρ.
  1. Initialize π₁ ← π_{ref}.
  2. for iteration t = 1, 2, ... , T do
  3. Construct Dₜ = { (x, y^{gold}) } where x ~ ρ and y ~ π_{gold}( · | x ).
  4. Sample batched on-policy responses: Sample K outputs per prompt using the
    current πₜ: {yₜ¹, yₜ², ... , yₜ^{K}} ~ πₜ( · | x ), ∀x ϵ Dₜ
  5. Rank responses: For each x ϵ Dₜ rank the corresponding {yₜ¹, yₜ², ... , yₜ^{K},
    y^{gold} } using the validation function V.
  6. Filter preferences: Construct Dₜ₊₁ = { (x, yₜ ) }, for all ∀x ϵ Dₜ₊₁ and yₜ is the
    highest ranking response for x from the previous step.
  7. Policy optimization: Obtain πₜ₊₁ by
${π}_{t + 1} ← {arg max}_{π ∈ \prod } {E}_{( x , {y}_{t} ) ∈ {D}_{t + 1}} η log ( π ( {y}_{t} \vert x ) )$
  8. end for
  9. return best of π_{1:(T+1)} on the validation data.
```

In Table 1, iterative policy (model weightings) optimization in steps 7-9 is implemented via a machine learning update method (e.g., in Azure® machine learning cloud-based environment for managing machine learning workflows). The AI model training unit 128 takes the responses output from the LLM 126a, applies existing labels and takes the finding a loss of a loss function (e.g., cross entropy loss is suitable for classification task) to calculate the gradient of the loss function of the LLM 126a. The AI model training unit 128 then uses the gradient to update the model weights. Comparing with DNO, the AI model training unit 128 constructs the same kind of rank responses, but without filtering the preference pairs or contrastive learning. Instead, the AI model training unit 128 applies a cost entropy in analysis and gradient update. The gradient update step 7 is used for self-supervised learning, i.e., the structure of labeling a model's own data and then using that to train the model). The AI model training unit 128 combines gradient update step 7 with the validation function V to outperform the existing policy optimization approaches.

For example, to generate the calendar, the AI model training unit 128 basically generates initial labels of what the calendar should look like, and has the LLM 126a make an initial pass on these initial labels. The AI model training unit 128 then runs the algorithm to update the model weights. After each iteration, the LLM 126a is slightly different from what it was originally. Once the model weights are updated, the AI model training unit 128 runs the query step over each of the input examples, to create a new calendar.

Fine-tuning a generative model requires a dataset that is specific to an intended task, thereby helping the generative model to learn the patterns and relationships that are relevant to the task, and to improve its performance. In one implementation, the model fine-tuning involves applying the synthetic data unit 152 to generate synthetic sample calendars from limited eyes-on calendar data, applying the formatting unit 154 to format the calendar data of the synthetic calendars into a text representation of the calendar surface, and executing a first pass of the LLM 126a over the text representation of the calendar surface. Such formatting step is optional, and then the validation unit 156 uses a validation function to score and select the best synthetic calendar for fine-tuning the LLM 126a as discussed. As a result, the validation function ranks multiple solutions generated for the same synthetic input in the deducted schedule format to be more time and resource efficient. The top-ranked solution is then used to implement an updating step that updates the LLM 126a, and the AI model training unit 128 uses AI preference feedback to iteratively improve the LLM 126a over itself as in the above-discussed implementations.

In one implementation, at the solution querying stage, the synthetic data unit 152 generates the synthetic calendar event data from the limited eyes-on calendar data associated with IT workers of interest, using a Python program (e.g., Generate.py 202) activated on the CLI on the user interface 305. A Python program can be executed via terminal, shell, or command prompt by simply invoking the python command followed by the desired script or interactive commands. The limited eyes-on calendar data is included in the raw resource allocation data 142. Using synthetic calendar event data promotes data privacy, reduces cost, allows data customization and augmentation, and increase scalability. On the other hands, synthetic calendar event data limits data accuracy, suffers from bias risks, resource dependence, and overfitting risks. The query-rank-train framework factors in these factors to decide how much synthetic event data to use depending on characteristics of the resource allocation tasks.

More details are provided for creating a substantial dataset for experimentation. The synthetic data unit 152 does not rely on actual calendar data, but synthesizes calendar event data based on a limited amount of volunteered calendar data. For instance, the synthetic data unit 152 gathers a small pool of real eyes-on calendar events from volunteers (e.g., a few IT workers, or several executive users), and then randomize them to a degree as a JSON list of objects with the schema shown in Table 2.

TABLE 2

{
“start″: ″2024-09-23 09:00:00″,
″durationMinutes″: 60,
″subject″: ″Sydney Offline Evaluation Office Hour″,
″room″: ″Microsoft Teams Meeting″,
″organizer″: ″Username1
″organizerEmail″: ″ username1@mail2time.com″,
″attendeeCount″: 300,
″state″: ″tentative″
},
{
″start″: ″2024-09-23 09:00:00″,
″durationMinutes″: 30,
″subject″: ″Responding (Synthesis) Office Hour's (WEST)″,
″room″: ″Microsoft Teams Meeting″,
″organizer″: ″Username@″,
″organizerEmail″: ″username2@mail2time.com″,
″attendeeCount″: 100,
″state″: ″tentative″
},
{
″start″: ″2024-09-23 10:30:00″,
″durationMinutes″: 30,
″subject″: ″Canceled: Product Intelligence Scrum″
...

The synthetic data unit 152 then synthesizes events with properties sampled from this initial pool in Table 2. For example, for each calendar, randomly sample 5 email domains from an email provider domain file (e.g., synthesize_calendar/name/free_email_provider_domains.csv). The first email domain is used as the organization's email domain, while others email domains represent email domains originating from outside the organization. For each event of this calendar, the synthetic data unit 152 randomly chooses a work week going back up to 300 weeks from now, then randomly generates k different events. The synthetic data unit 152 further generates synthetic resource allocation sample solutions 204 (e.g., the synthetic calendars/solutions) based on distributions of the raw resource allocation data 142 or preconceived properties and/or distributions, using the Python program (e.g., Generate.py 202) as the pseudo algorithm listed in Table 3.

TABLE 3

| | |
|---|---|
| 1. | Randomly select the workday of the week, hour and half-hour mark (at the hour or |
| | at the half-hour). Ideally, we would randomly select the duration of the meeting |
| | according to the probabilities across all durations seen in the initial pool, but used |
| | the following distribution instead due to our small pool: |
| | a. DURATION_OPTIONS = [ 30, 45, 60, 90, 120, 240] |
| | b. DURATION_PROBABILITIES = [0.3, 0.15, 0.25, 0.15, 0.10, 0.05] |
| 2. | Sample the organizer's email domain from domain list with the probabilities [0.9, |
| | 0.025, 0.025, 0.025, 0.025]. Ideally, this would be derived from natural data. |
| 3. | Randomly sample the first and last names of the organizer from the first |
| | (synthesize_calendar/name/baby-names.csv) and last |
| | (synthesize_calendar/name/surnames.csv) name CSV files, then randomly sample |
| | the email template from the following list. For example, choosing |
| | “{firstChar}{last}” as the template for the sampled name “Gerald Pearson” and the |
| | domain “outlook.com” would result in the email “gpearson@outlook.com”. |
| 4. | Without replacement, sample the nearest real event to the time slot. Start by |
| | collecting all events within a set radius of time on the same day of the week as the |
| | target start time. If no such event exists, repeat the procedure on all days of the |
| | week. If no such event exists, use a generic template event, such as a 1:1 meeting or |
| | a team meeting. |
| 5. | Mutate a copy of this event by using a randomly generated meeting room and an |
| | attendee count that is consistent in magnitude to the original event's attendee count. |

For instance, the preconceived properties and/or distributions include start times do not occur at particular minutes they occur in like half hours, 15 minutes. Normally, people do not schedule meetings for 14 minutes or 13 minutes. They go by 15-minute blocks. Another preconceived property is that Like names aren't random. Names do not usually contain numbers. In one implementation, the synthetic data unit 152 fits the initial pool of data with the preconceived properties and/or distributions, using the parameters of the preconceived distributions to generate new calendars.

More details are provided for the formatting function executed by the formatting unit 154. In one implementation, the formatting unit 154 uses a formatting function (wrote in a Python program, e.g., schedule_text_viewer.py 206) that converts a JSON list of calendar events into a textual representation of the calendar surface. In one implementation, the formatting function includes 3 hyperparameters listed in Table 4 to deduct the JSON list of calendar events to be leaner so as to process and validate faster.

TABLE 4
1. colWidth: The number of characters along each column's width.
2. heightZoom: The number of time segments per hour. For example, a
heightZoom of 4 means each row is 15 minutes. A heightZoom of 1
means each row is 1 hour.
3. maxNumSquishedEvents: The maximum number of events that can
occupy one row in a column under any day. If there are more events than
this threshold, the excess events will be logged but not displayed on the
text surface.

FIGS. 3A-3B are diagrams of example data views of a data dump and an allocation schedule prior to a validation function of an AI model training unit that implements the techniques described herein. FIG. 3A shows an example of the user interface 305 including a CLI in which the user is interacting with a program (e.g., python) to fine-tune generative models for resource allocation tasks. The user interface 305 includes a control pane 315, and a command pane 325. The user interface 305 may be implemented by the native application 114 and/or the browser application 112.

In some implementations, the control pane 315 lists a tab 315a for schedule_text_viewer.py, a tab 315b for { } [{“start”: “2023-04-10 09:00:00”, “durat Untitled-2, and a tab 315c for Result-hard.txt. The tab 315a for schedule_text_viewer.py can be selected to provide schedule generation functions. A user can select the tab 315a to create a resource allocation schedule shown in the command pane 325 in FIG. 3B based on a JSON data dump shown in the command pane 325 in FIG. 3A. As described later, the names listed in the data dump are synthetically created, to avoid privacy concerns. The user can select the tab 315b to display the JSON data dump file; { } [{“start”: “2023-04-10 09:00:00”, “durat Untitled-2. The user can select the tab 315c to display the converted schedule file: Result-hard.txt.

For example, the formatting unit 154 convers a JSON dump of a calendar shown in the CLI in FIG. 3A into a data string of a textual representation of the calendar shown in FIG. 3B, thereby reducing LLM prompting and reasoning (e.g., validation) load. FIG. 3B visualizes event time durations, open event slots, and conflicts between events in this textual representation, after the deduction operation on the JSON form in FIG. 3A. Since the structure of the textual representation is closely aligned to how important calendar event information is conveyed to human users, LLMs reason over this format better than the JSON format. One additional benefit of the textual representation is that it compresses the linear space requirement of a JSON calendar of events into a constant space. Any number of calendar events across a single week would still fit in the same number of characters in this representation, supporting strict adherence to LLM token constraints for the later validation function.

The formation function inevitably incurs some information loss, yet it has another benefit of precomputation of the preconceived properties. For example, the formatting unit 154 clearly sees conflicting events in FIG. 3B for additional deduction. Without the formatting function, the query-rank-train framework still works when the target generative models is good enough, and the to-be-processed data is small enough. However, as the to-be-processed data gets too large (e.g., 10,000 calendar events of software company employees), the formatting function can deduct the data into a preferred or predetermined size for validation, training, and/or subsequent processing.

More details are provided for the validation function executed by the validation unit 156. For each of the input examples, the AI model outputs many different possible calendars. In one implementation, at the solution ranking stage, the validation unit 156 executes a pass of an AI model (e.g., the LLM 126a) over the text representation of the calendar surface using a validation function to score and select the best synthetic calendar for fine-tuning the LLM 126a. In one implementation, the validation function is written in a Python program, e.g., validator.py 208.

Referring back to the task of IT worker calendar conflict resolution, the validation unit 156 applies a conflict resolution validation function that processes a list of rescheduling commands on each synthetic calendar/solution (e.g., Solution 1, Solution 2, Solution 3, . . . , Solution N) to output a respective real number score (e.g., 5.5, −100.3, −33.6, . . . , 4.8 in FIG. 2) for each synthetic calendar/solution. The score represents a combination of the following performance factors, and the performance factors (e.g., how organized a calendar is) are quantified as follows.
How much do the rescheduling commands disturb the calendar/solution (e.g., exponentiated by the number of attendees affected)? The less disturbance the better.
How much conflict will the rescheduling commands resolve in the calendar/solution? The more resolutions the better.
How many steps did the calendar/solution take to achieve these rescheduling commands? The fewer steps the better.

In one embodiment, the query-rank-train framework quantifies the disturbance caused by a rescheduling command by assuming that a single rescheduling command can only affect one event at a time. For instance, rescheduling commands can only change a duration or a start time of an event. Table 5 lists an example rescheduling command serialized as a string.

TABLE 5
reschedule(subject=“Data Platform Topic Deep Dive”,
previousStart=“2024-09-23 11:00:00”, newStart=“2024-09-23 09:00:00”,
reason=“Rescheduled to a free block that minimally impacts other
attendees.”)

The validation unit 156 parses these rescheduling commands from generative models and finds an event with the minimum Levenshtein distance between its subject and start times and the corresponding parameters of the rescheduling command. Then the rescheduling command operates on this event, thereby changing the event start time and/or duration.

The query-rank-train framework defines the magnitude of a duration change as the absolute percentage change from its original value, and the magnitude of a start time change as the fractional satisfaction of the following list of criteria:
1. Is the new start time inside work hours (defined as 9 am-5 μm Monday to Friday)? Disregard this criterion when the original start time is not during work hours.
2. Does the new start time occur at the same hour and minute marks as the original start time (thus the date does not matter for this criterion)?
3. Is the new start time on the same day of the week as the original start time?
4. Are the new and previous start times within one day of each other?
5. Are the new and previous start times on the same International Organization for Standardization (ISO) calendar week? (An ISO week always has seven days that contain days from the current month as well as the next month.)
6. Are the new and previous start times at most one ISO calendar week apart?

For example, if the validation unit 156 reschedules a meeting at 4 μm on Thursday Sep. 19, 2024 to three weeks later at 4 μm on Thursday Oct. 10, 2024, then this would satisfy criteria 1, 2 and 3, but not 4, 5 and 6. Since only half the criteria are satisfied, this start time change has a magnitude of 0.5 or 50%. Assuming the validation unit 156 instead reschedules a meeting at 4 μm on Saturday Sep. 21, 2024 to one day later at 4 μm Sunday Sep. 22, 2024. This satisfies criteria 1 (it is considered as passing the work hour test since the original start time is not during work hours), 2, 4 and 6, but it fails criteria 3 and 5. This start time change has a magnitude of 4/6 or around 67%.

In one implementation, the validation unit 156 models the impact of these changes on all attendees of the meeting as an exponent of a hyperparameter base to the power of the number of attendees of that meeting. When the validation unit 156 chooses 2 to be the hyperparameter base and a rescheduling command acted on a meeting of 5 attendees, then the impact is 32. When the hyperparameter base is set as 1, the impact is 1. In practice, this base hyperparameter should be derived from a dataset of scheduling behaviors depending on the resource allocation task of interest.

Lastly, the validation unit 156 defines the disturbance of a rescheduling command to be the magnitude of change it caused to the target event multiplied by impact on the attendees attending that event.

To quantify how much conflict will the rescheduling commands resolve in the calendar/solution, i.e., the improvement in calendar states, the validation unit 156 scores the quality of the calendars before and after transforming it with the sequence of rescheduling commands, by measuring the fraction of meeting time spent in conflicting meetings divided by the total meeting time. Since the validation unit 156 currently only accounts for a week's data, the meetings that were rescheduled outside this week's range are considered in conflict.

To quantify how many steps did the calendar/solution take to achieve these rescheduling commands, i.e., penalizing overcomplicated commands, the validation unit 156 decreases the output score by a penalty proportional to the number of rescheduling commands that act on calendar events. Since there are infinite ways to reschedule a calendar into a specific configuration, the validation unit 156 selects the calendar/solution with the shortest list of rescheduling commands.

In one implementation, the validation unit 156 combines the scores of the three performance factors into one score of the validation function. The validation unit 156 calculates a hyperparameter recipientExponentialDamageBase that uses the base exponent to measure event disturbance impact on attendees. The higher the value of this hyperparameter, the fewer manipulations to meetings with high numbers of attendees. The validation unit 156 multiplies the improvement in calendar state with another hyperparameter greedyConflictScoreWeighting. This hyperparameter represents the greediness of the algorithm. The higher the value of this hyperparameter, the more resolved calendars are even if it causes higher impact to other attendees. The validation unit 156 multiplies the complexity of a command sequence with another hyperparameter commandComplexityPenalty that penalizes complexity of the command sequence. The higher the value of this hyperparameter, the more a single shot complete resolution is preferred over stepwise resolution solutions.

The following example calendars, commands and score values are provided for the validation function calculation. The performance factors values, i.e., hyperparameters of the validation function are defined at the beginning of Table 6, followed by one example calendar with two event data points, and the output score of the validation function. The hyperparameters of the validation function in Table 6: recipientExponentialDamageBase as 1.1, commandComplexityPenalty as 0.05, and greedyConflictScoreWeighting as 10.0 are selected to optimize a specific resource allocation task, i.e., IT worker calendar conflict resolution. These are essentially arbitrary values experimented via trial and error to see whatever works the best for a specific resource allocation task.

The query-rank-train framework designs a validation function with particular hyperparameters and values to fine-tune a LLM for any other resource allocation tasks, such as optimal utilization of a warehouse, a recording studio, a surgery center, and the like. For instance, an event data point of a surgery center contain more parameters beyond a start, a duration, one or more resources (e.g., surgical table and equipment, medicine, surgeon, anesthesiologist, operating room nurse, surgical tech, physician assistant, and the like), and one or more resource consuming entities (e.g., patient A). Addition event parameters include a subject of the event (e.g., a cataract surgery), a state of the event (e.g., tentative), one or more roles of the one or more resource consuming entities (e.g., patients), a total count of the one or more resource consuming entities (e.g., 1), correlation data between the at least one resource and the one or more resource consuming entities, and the like. For this surgery scheduling conflict resolution task, the query-rank-train framework designs a validation function with more particular hyperparameters. One such hyperparameter is to schedule surgeries be closer together yet with sustainable overlaps to fully utilize the expensive medical professionals. A surgical center schedule has a higher score if its surgeries are closer together to share some medical professionals. Other hyperparameters concern the physical surgical facility limitations, such as the number of patients verses the cataract surgery equipment capability (e.g., a penalty value when the number of patients more than the cataract surgery equipment capability per day).

Rather than calculating strenuous mathematic formula to try to achieve a perfect solution, the query-rank-train framework designs a validation function with particular hyperparameters and values to fine-tune a generative model for a specific resource allocation task.

TABLE 6
def testDualNoChange( ):
validator Validator(
recipientExponentialDamageBase=1.1,
commandComplexityPenalty=0.05,
greedyConflictScoreWeighting=10.0,
)
calendar = [
{
“start”: “2024-09-23 11:00:00”,
“durationMinutes”: 60,
“subject”: “Data Platform Topic Deep Dive”,
“room”: “Microsoft Teams Meeting”,
“organizer”: “Username3”,
“organizerEmail”: “username3@mail2time.com”,
“recipientCount”: 7,
“state”: “tentative”
},
{
“start”: “2024-09-23 12:00:00”,
“durationMinutes”: 60,
“subject”: “Office AI Platform (Augmentation Loop) Office Hours”,
“room”: “Microsoft Teams Meeting”,
“organizer”: “Augmentation Loop Partners”,
“organizerEmail”: “augmentationlooppartners@service.mail2time.com
“recipientCount”: 30,
“state”: “tentative”
},
]
score, output = validator.score(
calendarJsonStr=json.dumps(calendar),
commandsStr=‘done (reason=“All conflicts have been resolved.”)’
)
assert output == calendar
assert score == 10.0

In Table 6, the two events of the calendar are not in conflict. The command is just a single done call and the expected score is just the greedyConflictScore Weighting value, or 10.0. Penalties for the number of impacted recipients or command complexity do not contribute to the final score. This is because there are no commands that change events in the calendar.

The next example case presents a calendar with two conflicting events in Table 7. The command is still just a done call and the expected score is 0.0. This is because no improvement is made to the existing conflict.

TABLE 7
...
calendar = [
{
“start”: “2024-09-23 11:00:00”,
“durationMinutes”: 60,
“subject”: “Data Platform Topic Deep Dive”,
“room”: “Microsoft Teams Meeting”,
“organizer”: “Username3”,
“organizerEmail”: “username3@mail2time.com”,
“recipientCount”: 7,
“state”: “tentative”
},
{
“start”: “2024-09-23 11:00:00”, # conflicts the first one
“durationMinutes”: 60,
“subject”: “Office AI Platform (Augmentation Loop) Office Hours”,
“room”: “Microsoft Teams Meeting”,
“organizer”: “Augmentation Loop Partners”,
“organizerEmail”: “augmentationlooppartners@service.mail2time.com”,
“recipientCount”: 30,
“state”: “tentative”
},
]
score, output = validator.score(
calendarJsonStr=json.dumps(calendar),
commandsStr=‘done(reason=“All conflicts have been resolved.”)’
)
assert output == calendar
assert score == pytest.approx(0.0)

Resolving event conflicts involves identifying overlapping events and finding a way to accommodate them without double-booking, such as moving a less important event to a different time slot. The system can establish clear guidelines/rules for scheduling events to avoid conflicts.

This next example case shows a calendar of two conflicting events in Table 8, but there is an additional command to reschedule the first event out of conflict and into a different time slot. The final score is the total reward for solving all conflicts (i.e., 10.0), subtracted by the penalty of one command (0.05) and the penalty of missing one start time rescheduling criterion (i.e., the new start time was not at the same time of the day as the previous start time) multiplied by the impact on the 7 recipients of that reschedule command (i.e., 1/6×1.1⁷). This start time change satisfies criterion 1 (i.e., the new start time inside work hours) yet fail criteria 2-6, thus has a magnitude of 1/6 or around 17%. As described, the numbers of 0.05 and 1.1 are determined by the hyperparameters of the validation function in Table 6.

TABLE 8
...
calendar [
),
“start”: “2024-09-23 11:00:00”,
“durationMinutes”: 60,
“subject”: “Data Platform Topic Deep Dive”,
“room”: “Microsoft Teams Meeting”,
“organizer”: “Username3”,
“organizerEmail”: “username3@mail2time.com”,
“recipientCount”: 7, “state”: “tentative”
},
{
“start”: “2024-09-23 11:00:00”, conflicts the first one
“durationMinutes”: 60,
“subject”: “Office AI Platform (Augmentation Loop) Office Hours”,
“room”: “Microsoft Teams Meeting”, “organizer”: “Augmentation Loop Partners”,
“organizerEmail”: “augmentationlooppartners@service.mail2time.com”, “recipientCount”:
30,
“state”: “tentative”
},
]
logBuffer( )
score, output validator.score(
calendarJsonStr-json.dumps(calendar),
commandsStr
reschedule(subject=“Data Platform Topic Deep Dive”, previousStart=“2024-09-23
11:00:00”, newStart=“2024-09-23 12:00:00”
previousDurationMinutes-60, reason=“Moving this meeting to a free slot.”)
done(reason=“All conflicts have been resolved.”)
logBuffer-logBuffer,
)
targetCalendar - [
{
“start”: “2024-09-23 12:00:00”,
‘end’: ‘2024-09-23 13:00:00’,
“durationMinutes”: 60,
“subject”: “Data Platform Topic Deep Dive”,
“room”: “Microsoft Teams Meeting”,
“organizer”: “Username3”,
“organizerEmail”: “username3@mail2time.com”,
“recipientCount”: 7,
“state”: “tentative”
},
{
“start”: “2024-09-23 11:00:00”, # no longer conflicts the first one
“durationMinutes”: 60,
“subject”: “Office AI Platform (Augmentation Loop) Office Hours”,
“room”: “Microsoft Teams Meeting”,
“organizer”: “Augmentation Loop Partners”,
“organizerEmail”: “augmentationlooppartners@service.mail2time.com”,
“recipientCount”: 30,
“state”: “tentative”
},
]
assert targetCalendar != calendar
assert output == targetCalendar
assert score-pytest.approx(10.0 − 0.05 − 1/6 * 1.1 ** 7)

The final example case uses the same events as the previous example case, yet the commands resolve the conflict partially in Table 9. The first command reschedules the first meeting into the mid-point of the second meeting, and the second command reduces the duration of the second meeting so that the two meetings only overlap by 15 minutes. The final score is the partial reward for resolving the conflicts (i.e., the full reward of 10.0 multiplied by the scaling factor of 1—current conflict fraction/previous conflict fraction), subtracted by the cost of the first start time rescheduling command (i.e., the cost of using one command and the impact of the single start time criterion violation on 7 recipients) and the cost of the second duration modification command (i.e., the cost of using another command and the impact of the reducing a 60 minute meeting into 45 minutes on 30 recipients).

```
TABLE 9
...
calendar [
),
″start″: ″2024-09-23 11:00:00″,
″durationMinutes″: 60,
″subject″: ″Data Platform Topic Deep Dive″,
″room″: ″Microsoft Teams Meeting″,
″organizer″: ″Username3″,
″organizerEmail″: ″username3@mail2time.com″,
″recipientCount″: 7, ″state″: ″tentative″
},
{
″start″: ″2024-09-23 11:00:00″, conflicts the first one
″durationMinutes″: 60,
″subject″: ″Office AI Platform (Augmentation Loop) Office Hours″,
″room″: ″Microsoft Teams Meeting″, ″organizer″: ″Augmentation Loop Partners″,
″organizerEmail″: ″augmentationlooppartners@service.mail2time.com″, ″recipientCount″:
30,
″state″: ″tentative″
},
]
score, output = validator.score(
calendarJsonStr=json.dumps(calendar),
commandsStr=’’’
reschedule(subject=″Data Platform Topic Deep Dive″, previousStart=″2024-09-23
11:00:00″), newStart=″2824-09-23 11:30:00″)
reschedule(subject=″Office AI Platform (Augmentation Loop) Office Hours″,
previousStart=″2024-09-23 11:00:00″, newStart=″2024-09-23 11:00:00″,
previousDurationMinutes-60, newDurationMinutes-45)
done( )
‘’’,
)
assert output == [
{
″start″: ″2024-09-23 11:30:00″,
′end′: ′2024-09-23 12:30:00′,
″durationMinutes″: 60,
″subject″: ″Data Platform Topic Deep Dive″,
″room″: ″Microsoft Teams Meeting″,
″organizer″: ″Username3″,
″organizerEmail″: ″username3@mail2time.com″,
″recipientCount″: 7,
},
{
″state″: ″tentative″
″start″: ″2024-09-23 11:00:00″,
″end″: ″2024-09-23 11:45:00″,
″durationMinutes″: 45,
″subject″: ″Office AI Platform (Augmentation Loop) Office Hours″,
″room″: ″Microsoft Teams Meeting″,
″organizer″: ″Augmentation Loop Partners″,
″organizerEmail″: ″augmentationlooppartners@service.mail2time.com″,
″recipientCount″: 30,
″state″: ″tentative″
},
]
assert score == pytest.approx(
10.0 * (
1
# current conflict fraction divided by previous conflict fraction
−15.0/105.0 * 120.0/60.0
) − 0.05 − 1/6 * 1.1 ** 7 # start time rescheduling command
  − 0.05 − 15/60 * 1.1 ** 30 # duration modification command
  )
```

The benefit of this validation function is that it bypasses constructing a target conflict resolution solution when supervising the LLM 126a. The target conflict resolution solution may be ill-defined to imitate real user behaviors, and/or perfect resolution for all attendees impacted by a single event change is exponentially-difficult to compute or even not computable. Instead, The query-rank-train framework provides a set of random calendars and the validation function to fine-tune the LLM 126a for a resource allocation conflict resolution task.

As shown in FIG. 2, Solution 1 has the highest performance score, thus selected by the AI model training unit 128 to send to the data labelling unit 158 for generating training data 146 for the model training stage. The data labelling unit 158 labels each of the datapoints with their top-ranked response y as the newly labeled data tailored to the specific task. This newly labeled dataset is clean, well-structured, and split into training, validation, and testing subsets. Once prepared, the data is tokenized using the tokenizer associated with the LLM 126a, converting text into a format the model can process.

The pre-trained LLM 126a can be sourced from platforms like Hugging Face, serves as the target generative model. During this phase, task-specific layers, such as classification or generation heads, are added to adapt the model for the desired application.

The AI model training unit 128 can configure key parameters like learning rate, batch size, and number of epochs, as well as select an appropriate loss function based on the resource allocation task. For example, the AI model training unit 128 runs a single epoch of training the LLM 126a based on the newly labeled data. The AI model training unit 128 then repeats this process for a set number of iterations to fine-tune the LLM 126a for the task of IT worker calendar conflict resolution. Training the LLM 126a requires monitoring performance metrics, such as accuracy, to ensure improvements on the validation dataset.

Once the LLM 126a is fine-tuned, the AI model training unit 128 evaluates the LLM 126a based on a reserved test set to measure its performance. Successful models are deployed for inference, with ongoing monitoring in production to maintain reliability.

By analogy, the AI-powered query-rank-train framework can be used to fine-tune other generative models. For instance, the system applies the framework to a vision model (e.g., a stable diffusion that learns to generate images) with a different validation function. For example, the train a vision model to output images with higher contrast, such validation function can reward or rate examples that have higher contrast.

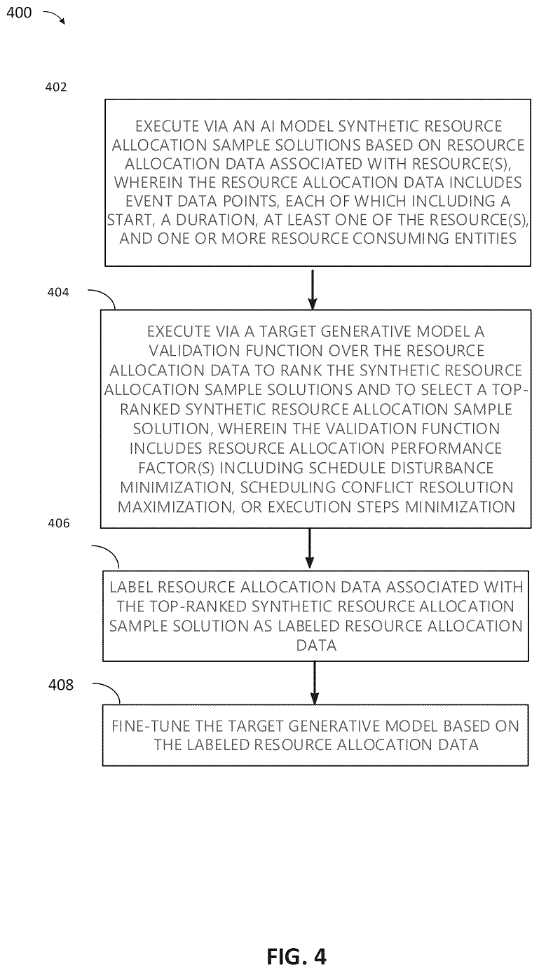

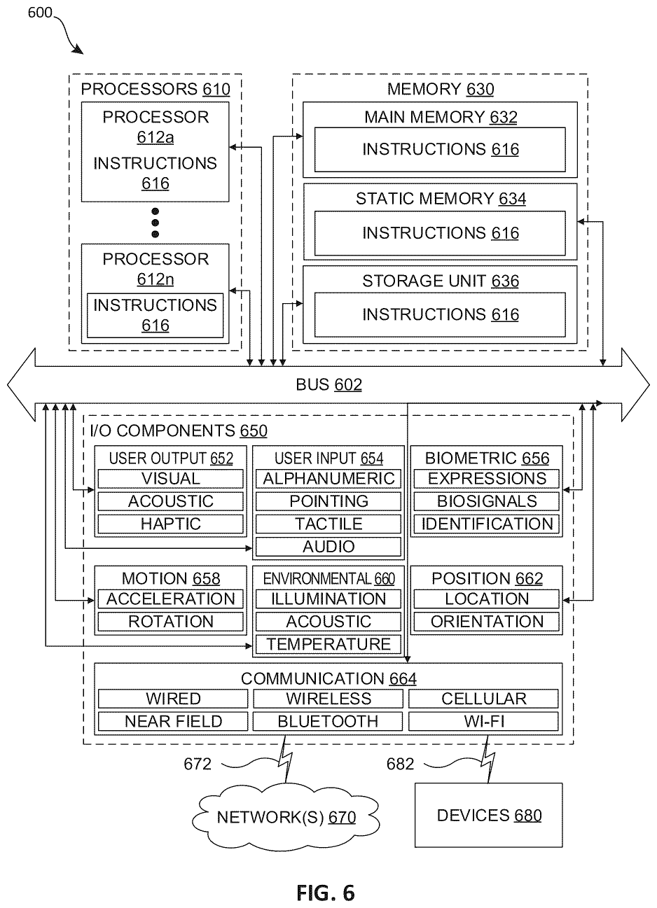

FIG. 4 is a flow chart of an example process 400 for fine-tuning generative models for resource allocation tasks according to the techniques disclosed herein. The process 400 can be implemented by the application services platform 110 or its components shown in the preceding examples. The process 400 may be implemented in, for instance, the example machine including a processor and a memory as shown in FIG. 6. As such, the application services platform 110 can provide means for accomplishing various parts of the process 400, as well as means for accomplishing embodiments of other processes described herein in conjunction with other components of the example computing environment 100. Although the process 400 is illustrated and described as a sequence of steps, it is contemplated that various embodiments of the process 400 may be performed in any order or combination and need not include all the illustrated steps.

In one embodiment, for example, in step 402, a prompt construction unit (e.g., the prompt construction unit 124) works in conjunction with the AI model training unit 128 to generate via an AI model (e.g., the LLM 126a) synthetic resource allocation sample solutions (e.g., Solution 1, Solution 2, Solution 3, . . . , Solution N) based on resource allocation data (e.g., the synthetic resource allocation data 144) associated with one or more resources. For example, the one or more resources include at least one of a physical space, a memory storage space, computation power, utilities, transportation capabilities, communication network capabilities, or workforce.

The resource allocation data includes event data points, and each of the event data points includes a start, a duration, at least one of the resource(s), and one or more resource consuming entities. One such event data point is listed in Table 2: (“start”: “2024-09-23 09:00:00”, “durationMinutes”: 60, “room”: “Microsoft Teams Meeting”, . . . ). As in a discussed example, the resource allocation data includes calendar data (e.g., the JSON data dump 325a listed in FIG. 3A), and the synthetic resource allocation sample solutions include synthetic calendars (e.g., the before adjustment calendars listed in Tables 6-9).

In other implementations, each event data point further includes at least one of a subject of the event (e.g., “subject”: “Sydney Offline Evaluation Office Hour”), a state of the event (e.g., “state”: “tentative”), one or more roles of the one or more resource consuming entities (e.g., “organizer”: “Xiaofeng X”), a total count of the one or more resource consuming entities (e.g., “attendeeCount”: 300), correlation data between the at least one resource and the one or more resource consuming entities (e.g., the room being on the same floor as the organizer's office).

The synthetic data unit 152 of the AI model training unit 128 can use user data associated with some volunteers from various user data source(s) to generate synthetic event data for model fine-tuning. The user data source(s) can be online/offline databases, documents, articles, books, presentation content, and/or other types of content containing user activity information. For instance, user data can be digitized and stored in the resource consuming entity database 132. For structured task data (e.g., calendar entries from calendar application(s), task entries from task management application(s), and the like), semi-structured task data (e.g., emails from email application(s), tweets, and the like), the AI model training unit 128 can apply the data directly to generate synthetic event data for model fine-tuning, without task/event extraction, which converts unstructured data into structured formats by identifying specific events and their components.

In one implementation, generating the synthetic resource allocation sample solutions based on the resource allocation data includes operations: randomly selecting a workday of a week (e.g., Wednesday) and a hour or half-hour mark (e.g., 1:30 μm) as the start of each event data point; randomly selecting the duration of each event data point according to heuristic or predetermined duration probabilities across all durations in an initial resource allocation data pool (e.g., the raw resource allocation data 142 form a limited amount of volunteered calendar data); sampling properties of resource consuming entities in the initial resource allocation data pool. The properties include resource consuming entities identification data (e.g., “Gerald Pearson”); generating hosting resource consuming entity data (e.g., “gpearson@outlook.com”) from the resource consuming entities identification data; and for each event data point, randomly generating a resource (e.g., “room”) and additional resource consuming entity data (e.g., “recipientCount”: 3) consistent in magnitude to additional resource consuming entity data in the initial resource allocation data pool.

In step 404, the prompt construction unit 124 works in conjunction with the validation unit 156 of the AI model training unit 128 to execute via a target generative model (e.g., the LLM 126a) a validation function (e.g., “Validator” in Tables 6-9) over the resource allocation data to rank the synthetic resource allocation sample solutions and to select a top-ranked synthetic resource allocation sample solution (e.g., Solution 1). In one implementation, the validation function includes resource allocation performance factor(s) including schedule disturbance minimization (e.g., recipientExponentialDamageBase=1.1), scheduling conflict resolution maximization (e.g., greedyConflictScoreWeighting=10.0), or execution steps minimization (e.g., commandComplexityPenalty=0.05). The target generative model is a generative model or a machine learning model different from the target generative model.

Optionally, before executing the validation function, the formatting unit 154 of the AI model training unit 128 formats the resource allocation data into a text representation of an allocation schedule (e.g., the allocation schedule 325b in FIG. 3B) based on one or more deduction hyperparameters. As such, the target generative model executes the validation function over the text representation to rank the synthetic resource allocation sample solutions. For instance, the one or more deduction hyperparameters include at least one of a character size per column (e.g., colWidth in Table 4), a number of time segments per hour (e.g., heightZoom in Table 4), or a maximum number of events per row in a column per day (e.g., maxNumSquishedEvents in Table 4) in the allocation schedule.

In step 406, the data labelling unit 158 of the AI model training unit 128 labels resource allocation data associated with the top-ranked synthetic resource allocation sample solution as labeled resource allocation data. In step 408, the AI model training unit 128 fine-tunes the target generative model (e.g., the LLM 126a) based on the labeled resource allocation data.

All the above-discussed resource data 140, raw resource allocation data 142, synthetic resource allocation data 144, training data 146, and request, prompts and responses 148 can be stored in an enterprise data storage 134. The enterprise data storage 134 can be physical and/or virtual, depending on the entity's needs and IT infrastructure. Examples of physical enterprise data storage systems include network-attached storage (NAS), storage area network (SAN), direct-attached storage (DAS), tape libraries, hybrid storage arrays, object storage, and the like. Examples of virtual enterprise data storage systems include virtual SAN (vSAN), software-defined storage (SDS), cloud storage, hyper-converged Infrastructure (HCl), network virtualization and software-defined networking (SDN), container storage, and the like.

There are security and privacy considerations and strategies for using open source generative models with enterprise data, such as data anonymization, isolating data, providing secure access, securing the model, using a secure environment, encryption, regular auditing, compliance with laws and regulations, data retention policies, performing privacy impact assessment, user education, performing regular updates, providing disaster recovery and backup, providing an incident response plan, third-party reviews, and the like. By following these security and privacy best practices, the example computing environment 100 can minimize the risks associated with using open source generative models while protecting enterprise data from unauthorized access or exposure.

In an example, the application services platform 110 can store enterprise data separately from generative model training data, to reduce the risk of unintentionally leaking sensitive information during model generation. The application services platform 110 can limit access to generative models and the enterprise data. The application services platform 110 can also implement proper access controls, strong authentication, and authorization mechanisms to ensure that only authorized personnel can interact with the selected model and the enterprise data.

The application services platform 110 can also run the generative model 126 in a secure computing environment. Moreover, the application services platform 110 can employ robust network security, firewalls, and intrusion detection systems to protect against external threats. The application services platform 110 can encrypt the enterprise data and any data in transit. The application services platform 110 can also employ encryption standards for data storage and data transmission to safeguard against data breaches.

Moreover, the application services platform 110 can implement strong security measures around the generative model 126 itself, such as regular security audits, code reviews, and ensuring that the model is up-to-date with security patches. The application services platform 110 can periodically audit the generative model's usage and access logs, to detect any unauthorized or anomalous activities. The application services platform 110 can also ensure that any use of open source generative models complies with relevant data protection regulations such as GDPR, HIPAA, or other industry-specific compliance standards.

The application services platform 110 can establish data retention and data deletion policies to ensure that generated data is not stored longer than necessary, to minimizes the risk of data exposure. The application services platform 110 can perform a privacy impact assessment (PIA) to identify and mitigate potential privacy risks associated with the generative model's usage. The application services platform 110 can also provide mechanisms for training and educating users on the proper handling of enterprise data and the responsible use of generative models. In addition, the application services platform 110 can stay up-to-date with evolving security threats and best practices that are essential for ongoing data protection.

In some implementations, the system provides a feedback loop by augmenting thumbs up and thumbs down buttons for each scheduled item in the user interface 305. If the user dislikes a task event item, the system can ask why and use the input to improve the resource allocation schedule. A thumbs down click could also prompt the user to indicate whether the event item was scheduled for too long, too short, or was assigned the wrong time slot.

In some implementations, the application services platform 110 includes a moderation services that analyze user prompt(s), user feedbacks, and responses generated by the generative models 126, to ensure that potentially objectionable or offensive content is not generated or utilized by the application services platform 110. If potentially objectionable or offensive content is detected in the user prompt(s), the user feedbacks, and the responses, the moderation services provides a blocked content notification to the client device 105 indicating that the prompt(s), the user data is blocked from forming the system prompt. In some implementations, the request processing unit 122 discards any user query that includes potentially objectionable or offensive content and passes any remaining content that has not been discarded to the request processing unit 122 to be provided as an input to the prompt construction unit 124. In other implementations, the prompt construction unit 124 discards any content that includes potentially objectionable or offensive content and passes any remaining content that has not been discarded to the generative models 126 as an input.

As discussed, the moderation services generate a blocked content notification in response to determining that the user queries, and/or the system prompt includes potentially objectionable or offensive content, and the notification is provided to the native application 114 or the browser application 112 so that the notification can be presented to the user on the client device 105. For instance, the user may attempt to revise and resubmit the user queries. As another example, the system may generate another system prompt after removing task data associated with the potentially objectionable or offensive content. The moderation services can be implemented by a machine learning model trained to analyze the content of these various inputs and/or outputs to perform a semantic analysis on the content to predict whether the content includes potentially objectionable or offensive content (e.g., language/image/sound).

The resource consuming entity database 132 can be implemented on the application services platform 110 in some implementations. In other implementations, at least a portion of the resource consuming entity database 132 are implemented on an external server that is accessible by the AI model training unit 128.

As mentioned, the application services platform 110 complies with privacy guidelines and regulations that apply to the usage of user data included in the resource consuming entity database 132 to ensure that users have control over how the application services platform 110 utilizes their data. The user is provided with an opportunity to opt into the application services platform 110 to allow the application services platform 110 to access the user data. In some implementations, the first time that an application, such as the native application 114 or the browser application 112 presents the data analysis assistant to the user, the user is presented with a message that indicates that the user may opt into allowing the application services platform 110 to access user data included in the resource consuming entity database 132 to support the AI model fine-tuning functionality. The user may opt into allowing the application services platform 110 to access all or a subset of user data included in the resource consuming entity database 132. Furthermore, the user may modify their opt-in status at any time by accessing their user data and selectively opting into or opting out of allowing the application services platform 110 from accessing and utilizing user data from the resource consuming entity database 132 as a whole or individually.

Therefore, the system can assist users to fine-tune generative models for different resource allocation tasks with more accurate and relevant results for targeted tasks as well as reduced cost. The AI-powered query-rank-train framework simplifies DNO thus reduces the resources needed for fine-tuning, saving time and computational expenses.

The AI-powered query-rank-train framework can be applied to fine-tune any generative models tailed for different resource allocation tasks in various applications (e.g., email applications, calendar applications, task management applications, software development applications, and the like) to generate a resource allocation schedule, via a chat interface. Such interactive, chat-based resource allocation assistance can help a user to generate the resource allocation schedule comprehensively, quickly and accurately.

In addition, the system provides users interactive tools to refine the resource allocation schedule, and infer actions to complete tasks in the resource allocation schedule. For example, the system uses generative AI to create a resource allocation schedule for a surgical center. Each task event is assigned with a discrete timeslot, inferred resources, resource consuming entities, and the like that provide context and relevant information to perform the task event. A user can use the AI-assisted resource allocation application at the start of a day and view a resource allocation schedule with task events and suggested actions to complete each task event.

The detailed examples of systems, devices, and techniques described in connection with FIGS. 1-4 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-4 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

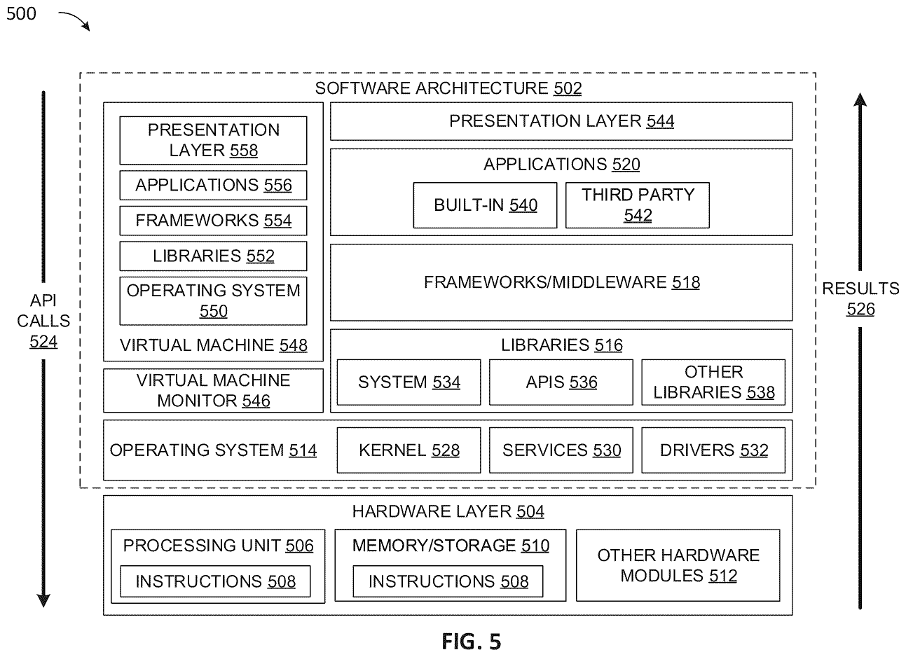

FIG. 5 is a block diagram 500 illustrating an example software architecture 502, various portions of which may be used in conjunction with various hardware architectures herein described, which may implement any of the above-described features. FIG. 5 is a non-limiting example of a software architecture, and it will be appreciated that many other architectures may be implemented to facilitate the functionality described herein. The software architecture 502 may execute on hardware such as a machine 600 of FIG. 6 that includes, among other things, processors 610, memory 630, and input/output (I/O) components 650. A representative hardware layer 504 is illustrated and can represent, for example, the machine 600 of FIG. 6. The representative hardware layer 504 includes a processing unit 506 and associated executable instructions 508. The executable instructions 508 represent executable instructions of the software architecture 502, including implementation of the methods, modules and so forth described herein. The hardware layer 504 also includes a memory/storage 510, which also includes the executable instructions 508 and accompanying data. The hardware layer 504 may also include other hardware modules 512. The executable instructions 508 held by processing unit 506 may be portions of the executable instructions 508 held by the memory/storage 510.

The example software architecture 502 may be conceptualized as layers, each providing various functionality. For example, the software architecture 502 may include layers and components such as an operating system (OS) 514, libraries 516, frameworks/middleware 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks/middleware 518 (also sometimes referred to as middleware) provide a higher-level common infrastructure that may be used by the applications 520 and/or other software modules. For example, the frameworks/middleware 518 may provide various graphic user interface (GUI) functions, high-level resource management, or high-level location services. The frameworks/middleware 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular platform. The applications 520 may use functions available via OS 514, libraries 516, frameworks/middleware 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement modules or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a neural processing unit (NPU), a tensor processing unit (TPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660, and/or position components 662, among a wide array of other physical sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 658 may include, for example, acceleration sensors (for example, an accelerometer) and rotation sensors (for example, a gyroscope). The environmental components 660 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 662 may include, for example, location sensors (for example, a Global Position System (GPS) receiver), altitude sensors (for example, an air pressure sensor from which altitude may be derived), and/or orientation sensors (for example, magnetometers).

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 664, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various implementations have been described, the description is intended to be exemplary, rather than limiting, and it is understood that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor, and
a machine-readable storage medium storing executable instructions which, when executed by the processor, cause the processor alone or in combination with other processors to perform following operations:
generating via an artificial intelligence model synthetic resource allocation sample solutions based on resource allocation data associated with one or more resources, wherein the resource allocation data includes event data points, each of which including a start, a duration, at least one of the one or more resources, and one or more resource consuming entities, and wherein the one or more resources include at least one of a physical space, a memory storage space, computation power, utilities, transportation capabilities, communication network capabilities, or workforce;
executing via a target generative model a validation function over the resource allocation data to rank the synthetic resource allocation sample solutions and to select a top-ranked synthetic resource allocation sample solution among the synthetic resource allocation sample solutions, wherein the validation function includes one or more resource allocation performance factors, and the one or more resource allocation performance factors include schedule disturbance minimization, scheduling conflict resolution maximization, or execution steps minimization;
labeling resource allocation data associated with the top-ranked synthetic resource allocation sample solution as labeled resource allocation data; and
fine-tuning the target generative model based on the labeled resource allocation data.

2. The data processing system of claim 1, wherein the machine-readable storage medium further includes instructions configured to cause the processor alone or in combination with other processors to perform:
before executing the validation function, formatting the resource allocation data into a text representation of an allocation schedule based on one or more deduction hyperparameters,
wherein the target generative model executes the validation function over the text representation to rank the synthetic resource allocation sample solutions.

3. The data processing system of claim 2, wherein the one or more deduction hyperparameters include at least one of a character size per column, a number of time segments per hour, or a maximum number of events per row in a column per day in the allocation schedule.

4. The data processing system of claim 1, wherein generating the synthetic resource allocation sample solutions based on the resource allocation data includes operations of:
randomly selecting a workday of a week and a hour or half-hour mark as the start of each event data point;
randomly selecting the duration of each event data point according to heuristic or predetermined duration probabilities across all durations in an initial resource allocation data pool;
sampling properties of resource consuming entities in the initial resource allocation data pool, wherein the properties include resource consuming entities identification data;
generating hosting resource consuming entity data from the resource consuming entities identification data; and
for each event data point, randomly generating a resource and additional resource consuming entity data consistent in magnitude to additional resource consuming entity data in the initial resource allocation data pool.

5. The data processing system of claim 1, wherein the machine-readable storage medium further includes instructions configured to cause the processor alone or in combination with other processors to perform:
in response to a user request, calling the target generative model as fined-tuned to execute conflict resolution on subsequent resource allocation data; and
providing the resource allocation data as executed to display on a user interface of a client device.

6. The data processing system of claim 1, wherein the artificial intelligence model is a generative model or a machine learning model different from the target generative model.

7. The data processing system of claim 1, wherein each event data point further includes at least one of a subject of the event, a state of the event, one or more roles of the one or more resource consuming entities, a total count of the one or more resource consuming entities, correlation data between the at least one resource and the one or more resource consuming entities.

8. The data processing system of claim 1, wherein the resource allocation data includes calendar data, and the synthetic resource allocation sample solutions include synthetic calendars.

9. A method comprising:
generating via an artificial intelligence model synthetic resource allocation sample solutions based on resource allocation data associated with one or more resources, wherein the resource allocation data includes event data points, each of which including a start, a duration, at least one of the one or more resources, and one or more resource consuming entities, and wherein the one or more resources include at least one of a physical space, a memory storage space, computation power, utilities, transportation capabilities, communication network capabilities, or workforce;
executing via a target generative model a validation function over the resource allocation data to rank the synthetic resource allocation sample solutions and to select a top-ranked synthetic resource allocation sample solution among the synthetic resource allocation sample solutions, wherein the validation function includes one or more resource allocation performance factors, and the one or more resource allocation performance factors include schedule disturbance minimization, scheduling conflict resolution maximization, or execution steps minimization;
labeling resource allocation data associated with the top-ranked synthetic resource allocation sample solution as labeled resource allocation data; and
fine-tuning the target generative model based on the labeled resource allocation data.

10. The method of claim 9, further comprising:
before executing the validation function, formatting the resource allocation data into a text representation of an allocation schedule based on one or more deduction hyperparameters,
wherein the target generative model executes the validation function over the text representation to rank the synthetic resource allocation sample solutions.

11. The method of claim 10, wherein the one or more deduction hyperparameters include at least one of a character size per column, a number of time segments per hour, or a maximum number of events per row in a column per day in the allocation schedule.

12. The method of claim 9, wherein generating the synthetic resource allocation sample solutions based on the resource allocation data includes:
randomly selecting a workday of a week and a hour or half-hour mark as the start of each event data point;
randomly selecting the duration of each event data point according to heuristic or predetermined duration probabilities across all durations in an initial resource allocation data pool;
sampling properties of resource consuming entities in the initial resource allocation data pool, wherein the properties include resource consuming entities identification data;
generating hosting resource consuming entity data from the resource consuming entities identification data; and
for each event data point, randomly generating a resource and additional resource consuming entity data consistent in magnitude to additional resource consuming entity data in the initial resource allocation data pool.

13. The method of claim 9, further comprising:
in response to a user request, calling the target generative model as fined-tuned to execute conflict resolution on subsequent resource allocation data; and
providing the resource allocation data as executed to display on a user interface of a client device.

14. The method of claim 9, wherein the artificial intelligence model is a generative model or a machine learning model different from the target generative model.

15. A non-transitory computer readable medium on which are stored instructions that, when executed, cause a programmable device to perform functions of:
generating via an artificial intelligence model synthetic resource allocation sample solutions based on resource allocation data associated with one or more resources, wherein the resource allocation data includes event data points, each of which including a start, a duration, at least one of the one or more resources, and one or more resource consuming entities, and wherein the one or more resources include at least one of a physical space, a memory storage space, computation power, utilities, transportation capabilities, communication network capabilities, or workforce;
executing via a target generative model a validation function over the resource allocation data to rank the synthetic resource allocation sample solutions and to select a top-ranked synthetic resource allocation sample solution among the synthetic resource allocation sample solutions, wherein the validation function includes one or more resource allocation performance factors, and the one or more resource allocation performance factors include schedule disturbance minimization, scheduling conflict resolution maximization, or execution steps minimization;
labeling resource allocation data associated with the top-ranked synthetic resource allocation sample solution as labeled resource allocation data; and
fine-tuning the target generative model based on the labeled resource allocation data.

16. The non-transitory computer readable medium of claim 15, wherein the instructions when executed, further cause the programmable device to perform:
before executing the validation function, formatting the resource allocation data into a text representation of an allocation schedule based on one or more deduction hyperparameters,
wherein the target generative model executes the validation function over the text representation to rank the synthetic resource allocation sample solutions.

17. The non-transitory computer readable medium of claim 16, wherein the one or more deduction hyperparameters include at least one of a character size per column, a number of time segments per hour, or a maximum number of events per row in a column per day in the allocation schedule.

18. The non-transitory computer readable medium of claim 15, wherein generating the synthetic resource allocation sample solutions based on the resource allocation data includes operations:
randomly selecting a workday of a week and a hour or half-hour mark as the start of each event data point;
randomly selecting the duration of each event data point according to heuristic or predetermined duration probabilities across all durations in an initial resource allocation data pool;
sampling properties of resource consuming entities in the initial resource allocation data pool, wherein the properties include resource consuming entities identification data;
generating hosting resource consuming entity data from the resource consuming entities identification data; and
for each event data point, randomly generating a resource and additional resource consuming entity data consistent in magnitude to additional resource consuming entity data in the initial resource allocation data pool.

19. The non-transitory computer readable medium of claim 15, wherein the instructions when executed, further cause the programmable device to perform:
in response to a user request, calling the target generative model as fined-tuned to execute conflict resolution on subsequent resource allocation data; and
providing the resource allocation data as executed to display on a user interface of a client device.

20. The non-transitory computer readable medium of claim 15, wherein the artificial intelligence model is a generative model or a machine learning model different from the target generative model.
